(19) United States
(12) Patent Application Publication
(10) Pub. No.: US 2008/0254848 A1
(43) Pub. Date: Oct. 16, 2008

(54) Gaming device having increasing odds of winning

(76) Inventor: Oladapo Olushile, Calumet City, IL (US)

Correspondence Address: Thomas J. Schab;Law Offices of Thomas J. Schab, 247 Ruth Street, Calumet City, IL, 60409, US

(21) Appl. No.: 11/787,284

(22) Filed: Apr. 16, 2007

(51) Int. Cl. A63F 13/00; G06F 19/00

(52) U.S. Cl. 463/16

(57) ABSTRACT

A gaming device having increased odds of winning includes a currency receiving device, a processor and associated memory in communication with the currency receiving device, and at least one information display device for displaying additional wagering information to a player. The currency receiving device is configured to receive and determine an amount of a wager deposited into the gaming device and to communicate this information to the processor. The processor contains internal source code to determine whether enough money has been inserted to continue play and if it has, it also controls game playing parameters for winning a predetermined jackpot. The jackpot consists of currency, casino chips or tokens, a debit card having an equivalent currency amount, or a printed, redeemable receipt that a player must redeem with the house gambling establishment. A secondary game of chance or advertisements could also be printed on the redeemable receipt.

### BACKGROUND OF THE INVENTION

1. Field of the Invention

The present invention relates to a method and apparatus for playing a video game of chance as would be found in casinos and other legal gambling establishments. More particularly, the present invention relates to a video gaming device that simplifies the traditional casino video style games of slots, poker or blackjack with uncomplicated rules and payout schemes, thereby appealing to the less-experienced gambler.

2. Discussion of the Prior Art

Many states other than Nevada and New Jersey now offer legalized gambling on either Indian reservations or riverboats. Thus, it can be appreciated that wherever the gaming establishment is located, the competition is fierce among land-based casinos and the gambling boat casino in attracting new and continued patrons to their particular gaming establishments. In order to continuously attract new patrons, especially older ones, there is a constant demand and need for new and improved games of chance.

One popular game that has been enjoyed by all ages of players is the slot machine. A slot machine is configured for a player to input a standard denomination of currency, a house token or even draw a monetary equivalent from a credit or debit card account to permit the player to activate the gaming device. Activating and playing the device causes a plurality of mechanical or electrical wheels to spin and ultimately stop to display a series of symbols. When certain, predetermined combinations of symbols are displayed, the player is considered a winner and the machine will either release coins, tokens or money into a payout chute, or register the win on a machine-based credit meter or on credit slips that are later redeemed at a payout booth within the casino.

Most casinos now market their own type of distinct and specialized slot machines that promise six-figure jackpots or they promote million dollar gaming tournaments, as a means to attract new patrons. For example, in order to provide for such lucrative payouts, most slot gaming machines are now of the progressive type, where the jackpots increase every time a player plays the slot machine. Along those same lines, some casinos even offer linked progressive slot machines which consist of two or more slot machines connected to a common jackpot, wherein each of the individual slot machines contribute to the total jackpot. With the individual progressive slot machines, the machine has a self-contained jackpot, which grows with every wager placed, based upon the house taking a certain percentage of the player's bet to its addition to the jackpot. As players see the jackpot grow, they become more incited to continue playing especially since most of these types of machines offer increased odds of winning as the jackpot becomes larger and larger.

However, one downside of slot machines and especially progressive ones, is that they require the player to place a threshold maximum bet in order to be eligible to win the large jackpots. Since most slot machines set the maximum bet per payline at five credits or five dollars per payline, many players are not willing to wager the full amount, or at least do so on a continued basis. Thus, if a player fails to play the maximum wagering amount, he will be precluded from a chance to win the really big payouts. Even when a player is willing to play all of the paylines, such wagers can collectively become very expensive experience for a player on a sustained basis since most slot machines display five reels and three symbols per reel, meaning that a machine may have five, nine or fifteen different paylines. When a player is required to bet even only a dollar on each payline, then effectively, only the true, die-hard gamblers will pay the price in order to be eligible to win the big jackpot. Another drawback to these types of progressive gaming devices is that if a player's bet exceeds the threshold level to enable the bonus jackpot, the player is not refunded or credited the overage should he lose on that particular play. Furthermore, should a player exceed the threshold, he will not be rewarded in any additional payout should he win. Based on the above, it can be appreciated that there is actually a penalty for not betting the maximum amount on each play and this penalty is also found in other types of gaming devices such as video roulette machines, video poker machines, and video blackjack machines. To this extent, it would be advantageous for a casino to provide a new type of electronic gaming device that encourages a continuous, multiplicity of patrons placing wagers to maximize the number of patrons and the dollars wagered at each gaming apparatus disposed within the casino. It would therefore be desirable to achieve that object by providing a gaming machine that is a simple to operate and requires a minimal wager to activate.

### SUMMARY OF THE INVENTION

It is a principal object of the present invention to provide a simplified gaming device having increasing odds of winning. The object is met by providing a gaming device that is comprised of a currency receiving device that is configured to receive and determine an amount of a wager deposited into said gaming device, a processor and an associated memory device in communication with said currency receiving device, and at least one display device for displaying additional wagering information to a player in order for a player to make a decision to continue playing or not. The processor includes means for activating and controlling play of the gaming device based upon an amount of any wager received by said currency receiving device.

In an aspect of the invention, an initial, minimum wager must be deposited into the gaming device in order to activate further play of the gaming device. Once activated, the player is presented with further gaming information on the display devices and this information will allow a player to decide if he should further wager. The information specifically includes how much money a player would have to wager to win the jackpot and how much money the money has received since the last payout. The information also includes what player number the current player represents since the last jackpot was awarded. If the current player number matches a predetermined player number, that player automatically wins the jackpot with no further wagers.

In another aspect of the invention, the gaming device pays out the jackpot in the form of a credit receipt that is to be redeemed at the gambling establishment. In still another aspect of the invention, the receipt has a secondary game of chance printed on the receipt. The secondary game includes some indicia marked on the receipt whereby if the player matches the indicia that is chosen by the gambling establishment, he can win a secondary prize.

The features and advantages of the invention will be further understood upon consideration of the following detailed description of an embodiment of the invention taken in conjunction with the drawings, in which:

### BRIEF DESCRIPTION OF THE DRAWINGS

FIG. 1 is a frontal view of the gaming device according to the preferred embodiment of the present invention;

FIG. 2 is a block diagram of the electronic hardware for implementing the system for effecting game play on the gaming apparatus of the present invention;

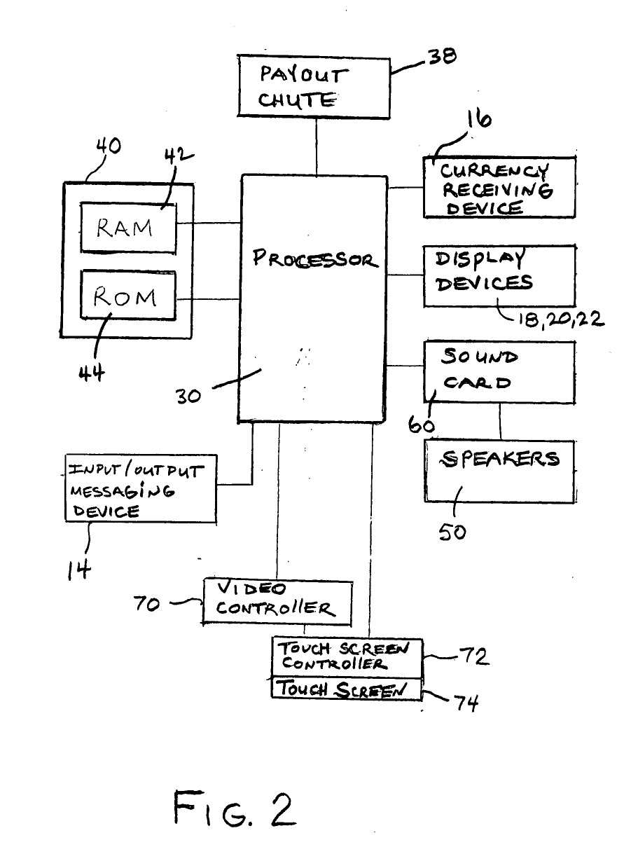

FIG. 3 is a flow chart depicting the operation of a wager control system according to the preferred embodiment of the present invention;

FIG. 3A is a flow chart depicting the operation of the processor generating a random number for use in setting a minimum dollar wager amount to activate the gaming device; and

FIG. 4 is a flow chart depicting an additional operation of a wager control system according to the preferred embodiment of the present invention.

### DETAILED DESCRIPTION OF A PREFERRED EMBODIMENT

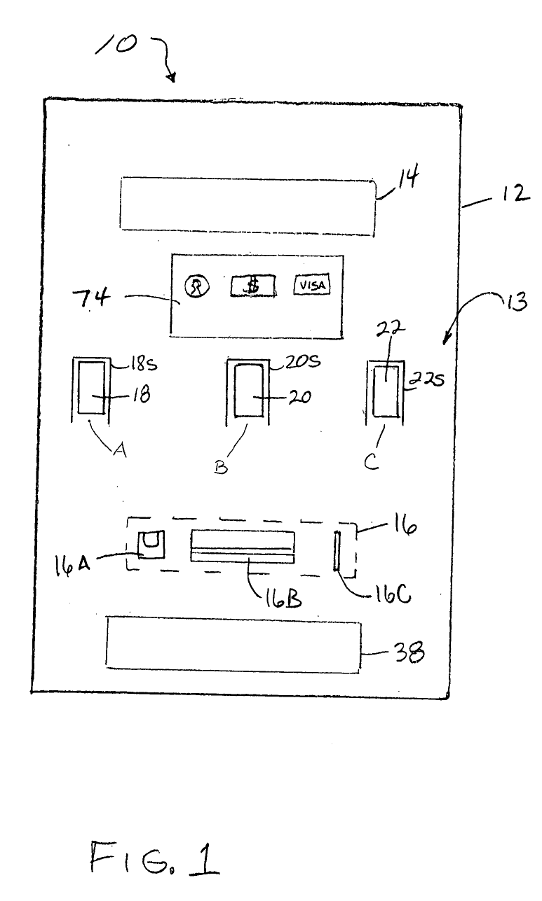

Referring to FIG. 1, the simplified gaming device 10 according to the present invention is shown comprising a housing structure 12 that includes a number of display windows and an internal computer system to control play of the game. The housing structure 12 is to be constructed so that it best adapts to the particular establishment that it will be placed within. For example, when placed within a casino, housing structure 12 may be constructed as a tall, freestanding cabinet like the one depicted in the drawing figure, thereby allowing a player to stand while wagering. In other establishments such as sports bars, structure 12 might best be constructed as a tabletop (not shown) in order to allow the player to wager while sitting. As illustrated, housing structure 12 presents a front face 13 that is provided with a programmable input/output messaging device 14 which has a large display window. The device 14 is of the well-known type that uses a keyboard to input a desired message that will be displayed in LCD form across the window thereof. The message will constantly scroll or scan across the lateral width of the window even when gaming device 10 is idle. Typically, the message that will be displayed will consist of the rules on how to play the game and instructions to a potential player on how to initially activate the gaming device 10. In another embodiment of the invention, the messaging device 14 is excluded and the gaming instructions are printed on front face 13 at a convenient location for a player to readily see and read.

The gaming device 10 is also generally configured electronically with an internal computer system that controls the initial activation of the gaming device, play of the game and payout of the prize winning jackpot. The input/output messaging device 14 is preferably a programmable component that is separate from the computer system, although messaging device 14 could be coupled to the computer system if a random number generator program is utilized to generate a randomly-changing game-activation wager, which will be explained later herein. The computer system generally comprises a processor 30 coupled to a memory device 40 for storing program code or other data. The memory device 40 includes a first portion that is comprised of random access memory 42, or RAM, for storing event data or other data generated or used during the game. The memory device 40 also includes a second portion that is comprised of read only memory 44, or ROM, for storing program code that controls the gaming device 10 in accordance with the game rules and the predetermined payout scheme. Other periphery components comprising a part of gaming device 10 and which are also in communication with processor 30 and/or memory device 40 are the display devices 18,20,22; a currency receiving device 16, speakers 50; a sound card 60; a video controller 70; a touch screen controller 72; and a touch screen 74. In instances where credit and debit cards are used as the means of currency for placing a wager, the video touch screen 74 and associated touch screen controller 72 are preferably used to input information into the processor 30 through a video controller 70.

To activate gaming device 10 and initiate activation and play of the wagering game, a player must input something of representative value, usually a standard denomination of currency, a house token or debit card, or a personal debit or credit card into the currency receiving device 16. The currency receiving device 16 is not to be limited to only one type of device that is dependent upon the type of currency being used. By that it is meant that currency receiving device 16 may comprise one or a combination of all known mechanical and/or electronic devices that accept and determine the value of deposited coins, tokens, bills, and/or credit and debit cards, etc., so that a player can use the same or a combination of all types of currency to play the game. For example, currency receiving device 16 may comprise a dedicated slot for receiving and determining the value of coins or tokens (16A), a slot dedicated for receiving and determining the value of all denominations of bills (16B), and/or a separate and dedicated slot (16C) for establishing credit and/or determining credit available when using personal credit/debit cards or credit/debit cards issued by the particular gaming establishment. When a player initially approaches gaming device 10, video screen 74 in the form of a touch screen will present touch-screen symbols that allow him to chose a desired form of currency for game play and he will be directed by a touch screen controller 74 connected to said screen 72 to touch-indicate his choice. A player can touch-chose a symbol of a coin, a bill, a token, a debit card, a credit card (by company) or a house debit card. After making his choice, the screen will instruct the player to insert his chosen form of currency into one of the appropriate deposit slots, 16A, 16B or 16C. The touch symbols and instructional directions are generated by a video controller which is connected to processor 30, as are the touch screen controller 72 and touch screen 74. The currency receiving device 16 is also in communication with processor 30 so that after one of the forms of currency are deposited within the currency receiving device 16 and an amount of deposit is determined, that information is sent to processor 30 for comparison with a value stored in memory 42 in order to determine if a predetermined amount of currency required to activate the gaming device has been received. If the predetermined amount (activation amount) has been received, a player will hear speakers 50 emit a musical jingle and/or make an announcement that acknowledges the player has been approved to continue playing the game. Simultaneously, the display devices 18, 20 and 22, simultaneously light up and appear to the player in the form of an LCD display within respective windows of the display devices. When the display devices 18-22 are activated, they immediately present a player with key information that he must quickly analyze to decide whether he wants to continue playing. If a player decides to continue, he must inset his wager into gaming device 10 within a predetermined period of time, referred to as the cut-out time. If he does not, the processor 30 will discontinue powering the display devices 18-22, causing the LCD lights to go dead, effectively causing gaming device 10 to simultaneously shut down except for the input/output messaging device 14. It is envisioned that a player will only be given a short amount of time, such as 20 seconds, to insert his gaming wager (additional currency) into the gaming device 10. Likewise, should a player review the information shown in display devices 18-22 and decide not to continue play, the display devices will eventually go dead and the gaming device shut down after the cut-out time has elapsed. The cut-out time allotted for making a decision to play or not to play is predetermined and stored within the memory 42 of the computer system and the predetermined 20 second time period should not be considered as a limitation to the invention. Part of the skill of the game is the result of forcing a player to quickly analyze the presented information before making a decision to continue playing, and then to have a gaming wager placed within the cut-out time period. Keeping the cut-out period short is favorable to the gaming establishment because many players will not react quick enough prior to depositing their gaming wager. Should the display devices 18-22 go dead before a timely gaming wager is placed by the current player, gaming device 10 effectively shuts down into a hibernation mode, where the messaging device 14 will be the only window lit up on the front face 13 of housing 12. A player will not get the machine to reactivate until another player or even the same player re-deposits the minimum value of currency into the machine (activation wager) in order to re-power the display devices 18-22. In those situations, the house will be guaranteed to collect at least the activation wager from player to player.

In another embodiment of the invention, the inputting of any wager amount into the gaming device is solely controlled by the use of the currency receiving device 16 since this device is independently capable of verifying and determining the amount of currency being deposited into gaming device 10. By that it is meant that the touch screen 74, the touch screen controller 72, and the video controller 70 are not provided as part of the invention because a player can be instructed either through messaging device 14 or by instructions printed on front face 13 on how to deposit his wagering monies into one or all of three dedicated slots 16A, 16B or 16C so as to initially activate gaming device 10 or to continue play with an additional wager.

As FIG. 1 also shows, each display device 18-22 is provided with a respective viewing protection shield, 18s, 20s, and 22s that shrouds the display window of each device. In that way, should a player walk away from the game before the allotted cut-out time, the information that is displayed on display devices 18-22 will not be seen by a potential player who was standing in the background or trying to look over the shoulder of the current player. Preventing a potential player from seeing this information will force him to also insert money into gaming device 10 in order to re-activate the game and display the key information needed for winning the jackpot. It should be understood that the protection shields 18s-22s project out of the plane of the paper and should extend at least two to three inches away from front face 13 in order to ensure complete shrouding of the display devices 18-22.

The information that a player sees displayed in the display devices 18-22, is specific information that is needed by the player in order to strategize on how to win the jackpot. For example, specific to display device 18, a player will immediately see how many previous players have played the game prior to his activation of the gaming device, information which directly impacts the current player's odds of winning the game. On the face 13 of the gaming structure 12 the words “Current Player Number” are permanently printed directly below the display device 18 but within the span of protection shield 18s. In FIG. 1, that information will be generally located in the area designated with the letter “A.” Likewise, specific to display device 20, a player will simultaneously see how many dollars have been previously deposited into the gaming device 10 since the last jackpot was awarded, information which also directly impacts the player's odds of winning the game. On the face 13 of structure 12, the words “Dollars Already Played” are permanently printed directly below the display device 20 and within the span of protection shield 20s. Again, that information will generally appear in the area designated with the letter “B.” Likewise, specific to display device 22, a player will simultaneously see how many net dollars are need to be deposited into the gaming device 10, in order to satisfy the monetary criteria needed to win the jackpot. On the face 13 of structure 12, the words “Net Dollars To Win” are permanently printed directly below the display device 22 and within protection shield 22s, generally in the area designated with the letter “C.” If a player satisfies the criteria to win the jackpot, which will be explained in detail later herein, a predetermined jackpot payout will be delivered to the player through a payout chute 28. The winnings are preferably paid directly to the player in currency, preferably in the form of bills, although the invention is not to be so limited such that payout chute 28 may also be capable of dispensing house tokens, house casino chips, house discount coupons or even a debit card having the cash equivalent thereon of the jackpot payout.

In another embodiment of the invention, the winnings may be dispensed in the form of a printed paper receipt that is ejected from payout chute 28. The receipt will indicate the jackpot total in dollars and it will have to be redeemed at a cash-in station at the gaming establishment where the machine is located so that a player can receive his winnings. The receipt may also display other additional information that the gambling establishment may consider important such as the tracking of the particular machine, the time of winning, the number of winners that day on that machine, etc. In a third embodiment of the invention, the receipt also serves as a play on a secondary game of chance or some form of a secondary promotion, in addition to its primary function of serving as a winnings credit slip. For example, the receipt can be marked with a distinct indicia such as a single or plural number, geometric symbol, animal, letter or a combination of all such indicia, wherein the winning indicia is coordinated and chosen by the gambling establishment. When the player's receipt matches the posted indicia at the cash-in booth, then the player wins a secondary payout. The posting of the indicia necessary to win the secondary game could also be posted on the establishment's web site, their in-house television programs or in any manner they establish. It is envisioned that the gambling establishment may also rotate the winning indicia on a predetermined cycle, such as hourly, daily, weekly, or monthly, etc., whereby at least one secondary winner will be established for each of the predetermined cycles. Of course, there may be more than one secondary winner for each predetermined cycle and the invention is not to be so limited. The secondary payout can take any form desired by the establishment, such as currency, casino chips, house tokens, a debit card for use only within that establishment, etc. The form of secondary payout is not to be considered a limitation to this embodiment of the invention. Alternatively, the secondary payout can in the form of cash, a discount, or credit for merchandise or services at a third party advertiser. For example, the secondary game of chance printed on each receipt can be sponsored by a local restaurant, nightclub, rental car company, etc., so that their business establishment is awarding the secondary payouts as a means of drawing these same casino patrons to their businesses too. The third party would pay the gambling establishment money in exchange for the exclusive rights to the secondary game of chance on the printed receipts.

The present invention, unlike most other gaming devices, does not include a dedicated wagering activation device such as a pull-down handle, a wagering push button, or some other dedicated means of activating the play of the game. Rather, with the present invention, a minimum wager (activation wager) necessary to activate gaming device 10 out of its hibernation mode and into an active play mode is controlled by the currency receiving device 16 in conjunction with processor 30. As a wager is deposited into the currency receiving device 16; the device will read and/or verify that the correct, predetermined amount of currency has been deposited into the machine to allow continuance of play. This information is communicated to processor 30, which in turn, communicates this same information, plus additional information to the display devices 18-22. If the proper activation wager is not received, the processor 30 communicates a power-down signal to the display devices. Likewise, after the display devices 18-22 are activated, any further dollar amount that is to be wagered will be internally verified by receiving device 16, with this information then communicated to processor 30. The activation wager amount and any further gaming wager amount is information that is processed by processor 30 in determining whether the criteria needed to win the jackpot has been satisfied. When gaming device 10 is out of its hibernation mode, display devices 18-22 will be displaying the most recent data that has been retrieved from the computer system's memory 40. As previously mentioned, with the best mode of the invention, the display device 18 will actively indicate which player number the current player represents since the last jackpot payout, while display device 20 will actively indicate how many dollars the machine currently requires to reach the predetermined dollar value of that gaming device, and display device 22 will actively indicate the net dollar amount required to be inputted into the gaming machine in the form of a wager in order to win. With this critical information being simultaneously shown on display devices 18-22, the player must quickly utilize the currency receiving device 16 to deposit the exact wager amount needed to win, should he decide to continue playing. In another embodiment of the invention, the display of the current player number (information in display device 18) and/or the dollars already inputted or played into the gaming device (information in display device 20) do not have to be physically displayed on face 13 of gaming device 10 to a player, such that only the dollars needed to be inputted into gaming device are shown (information in display device 22). However, by showing the information from all three categories, a player must digest more information in a timely fashion, increasing the house odds that he will not timely react prior to the cut out time powering down the machine.

The goal of the game is to win the jackpot in one of two ways, whereby the jackpot payout will remain constant no matter how many dollars the player wagers into the machine. In a preferred embodiment, the jackpot will pay out one half of the machine's designated dollar amount. For example, if the machine were designated as a $100 machine, a player will be wagering to win a jackpot having the constant, predetermined payout of ($50) fifty dollars. Of course, the payout ratio is not to be considered a limitation to the invention. Play of the game of the present invention proceeds as follows. First, a person who wishes to be considered an active player must place a minimum value of currency, tokens, credits, etc., into the currency receiving device 16 of the machine. The minimum dollar value of the wager needed to activate the gaming device 10 is information that is continuously displayed on the input/output messaging device 14. It is preferred that the minimum activation wager be a predetermined or constant value and it is also preferable to set this value at one percent of the designated dollar amount of the gaming device. For example, if a machine requires a hundred dollars ($100) of total input in order to win the jackpot, (a $100 designated machine), then the minimum amount of money needed to activate play will always be $100×(0.01), or one dollar ($1). It should also be understood that any dollar amount can be assigned to a particular machine. For example, gaming device 10 could be designated as a $500 or $1000 machine, or any desired amount for that matter since assigning a designated dollar amount to a machine is controlled by programming the processor 30 with that desired designation. The dollar amount that is designated to a machine should not be considered as a limitation of the present invention, nor should the dollar amount needed to activate gaming device 10. However, it is preferable that the predetermined, minimum activation dollar amount be limited to be somewhere between 1-5% of the designated dollar value of the machine (between $1-5 dollars for a $100 dollar machine) so that the activation amount will remain relatively low in order to attract a greater volume of players.

In another embodiment of the invention, instead of the minimum dollar activation wager being a predetermined and constant value, it is to randomly change to a value that fluctuates between 1-5% of the designated dollar value of the gaming device. This can be accomplished by programming processor 30 with a random number generator, wherein a number between 1 and 5 is generated prior to activation. The generated random number is then converted by processor 30 into a percentage value, whereby this percentage value is then multiplied against the dollar value of the machine so that a random, minimum dollar activation amount is finally generated. This random activation dollar amount is then displayed on the input/output messaging device 14 to show a potential player what minimum activation wager amount will be required prior to starting play. When a random activation mode is utilized, processor 30 will be programmed to prevent the situation where the minimum random dollar activation amount could be greater than the net dollar amount that is required to be deposited into the machine in order to win the jackpot. Preventing that situation is accomplished by processor 30 constantly comparing the net value of the dollars needed to win the jackpot with the generated random activation dollar amount. Whenever processor 30 determines that the net amount to win is five dollars or less, and that this amount is less than the random minimum activation dollar amount that was initially generated, then the processor is programmed to automatically convert from a random generator to a constant generator. In that situation, the minimum activation dollar amount will once again be set to the lowest possible minimum dollar activation amount, which is this case would be one dollar ($1) and this information will be displayed on input/output messaging device 14.

With either embodiment, once the activation dollar amount is entered into the currency receiving device 16, the player will see the gaming machine come to life. The display devices 18-22 will immediately power up and the information needed to strategize on how to win the jackpot, as described above, will be displayed in LCD form. The player has two simple ways of winning the jackpot, with the first being completely independent from the second. The first way is for the player to meet the predetermined criteria that he is the 100^{th} player of the gaming device 10 since the last jackpot was paid. When devices 18-22 light up, a player will see what player number he presents since the last payout in display device 18. If the current player happens to be the 100^{th} player, he does not have to enter any additional gaming wagers into the gaming device and he will be considered to be an automatic winner of the jackpot. An announcement accompanied by a musical jingle will be sounded to let the player know that he is the 100^{th} player and an automatic winner. Assignment of how many players must activate the machine prior to automatically awarding a jackpot winner is a matter of choice, however, it is preferable to correspond the winning player number with the dollar amount assigned to the machine, presuming that the machine will be programmed as requiring the lowest activation dollar amount. For example, if a machine were designated as a $500 machine, and a one percent activation amount was required ($5) to continue play, then the 100^{th} player would automatically win the jackpot because the machine received its designated amount. The number of players needed to activate the machine for an automatic payout should not be considered a limitation on the invention. However, when the number matches the dollar amount of the machine, the house will potentially generate more revenue compared to a machine set with a lower player number. In a variation to this embodiment, display device 18 would not be utilized so as to show this information to a current player. Rather the player number information could be internally stored within memory 40 such that when the 100^{th} player entered his activation wager into the currency receiving device 16, the processor 30 would internally make this determination and automatically sound the winning announcement or jingle to the player.

The second way a player can win the jackpot is by being the first player to exactly reach the designated dollar amount of gaming machine. With a designated one hundred dollar machine ($100), the goal of the player is to be the first one who exactly reaches the $100^{th} dollar inputted into the machine, accounting for the sum total of all the previous wagers and activation wagers ($1 each) that were deposited into the machine. For example, lets assume that the very first player after a jackpot has been paid activates gaming device 10 by depositing his activation dollar into the machine. He will see display device 20 light up to show him the dollar amount that must be deposited into the machine in order to win the jackpot, which will be the designated dollar amount of the machine, in this case $100. The display device 22 on the other hand, will show the net amount of dollars needed to win the $50 jackpot, which will now be $99. The net dollar amount reflects the total dollar amount of window 20, minus the amount of money the player deposited to activate the gaming device, which in this case is one dollar ($1). In most circumstances, the difference in values between display devices 20 and 22 will only be the dollar value of the machine's activation dollar amount, but in some circumstances the difference will be greater whenever a player happens to deposit more than the minimum activation wager into the machine. Gaming device 10 will not penalize a player for initially depositing more than the activation wager into the machine. Rather, memory 42 will store that number (any amount initially deposited) and then subtract that amount from the total dollars needed to reach the $100 total (display window 20). In this way, a player is given credit for all of the wager money used to activate play, no matter what the amount he initially deposits. When the first player after the jackpot payout sees that he must wager $99 to reach the dollar total ($100) of the machine, he will probably decide not to continue play. Otherwise, he would be required to input $99 into the machine to win a $50 jackpot. In that case, the player would probably walk away from the machine and his discontinued play would cause the display devices 18-22 to power down and go blank due to the cut out time being reached. The gaming device 10 would then stand in an idle state until the next player arrives. The cycle will continue until values shown in the display devices 20 and 22 show that the required dollar amount needed for a win gets closer to a breakeven wager amount or that the player who is actively playing is getting closer to being the 100^{th} player (the information in display device 18). Getting closer to breakeven or better is a matter of the player knowing exactly when he will break even or come out ahead. For example, assume that the 49^{th} player has activated gaming device 10. He will be presented with information in display devices 18-22 which indicate that he is the 49^{th} player since the last jackpot (display 18), and is not an automatic winner. Display device 20 will show him that the machine needs $51 more dollars to reach the $100 machine total, while display device 22 will show him that if he inputs $50 (net amount), he will win the $50 jackpot. Based upon this example, it should be appreciated that whenever a player sees a value in display device 22 that is $49 dollars or less, then he will monetarily benefit by making the wager. In the case where display 22 has a value of $49, then he would insert that exact amount into gaming device 10 in order to win the $50 jackpot, netting him a dollar in total net gain by placing the wager. Thus, it should be understood by the above examples, that it is actually more beneficial to any particular player to have as many previous players as possible so that the net amount needed to win goes down. Of course, a player will not know this critical information until only after he inserts the activation wager amount in order to light up display devices 18-22 or to become an automatic winner.

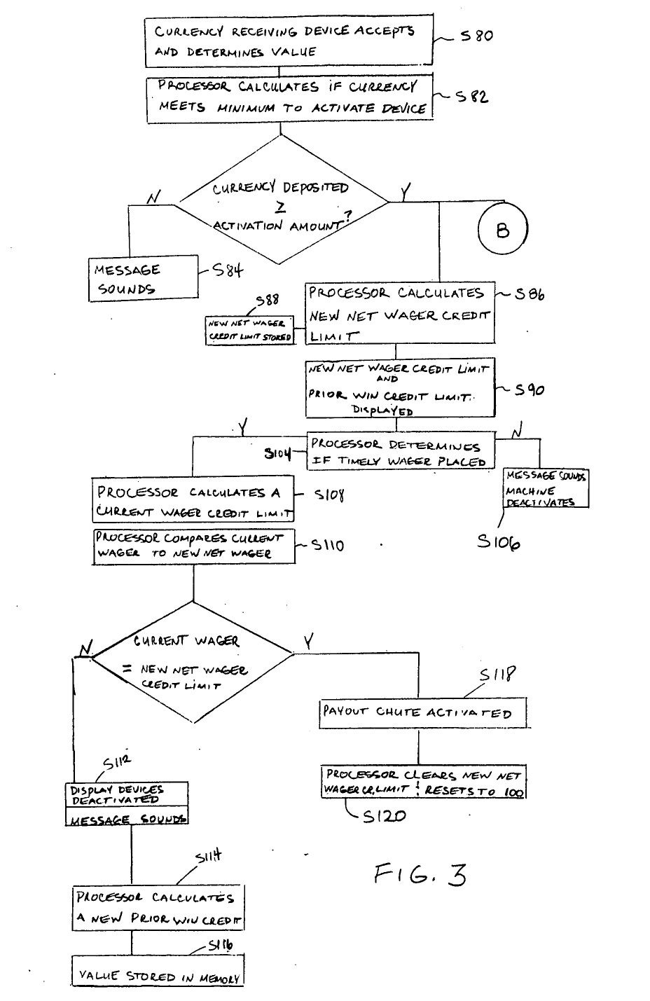

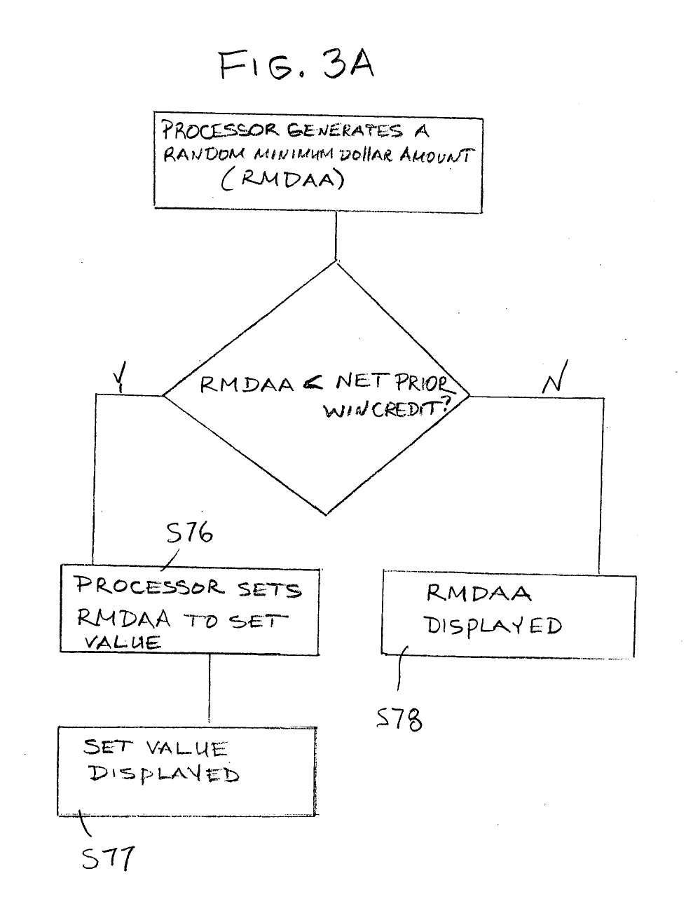

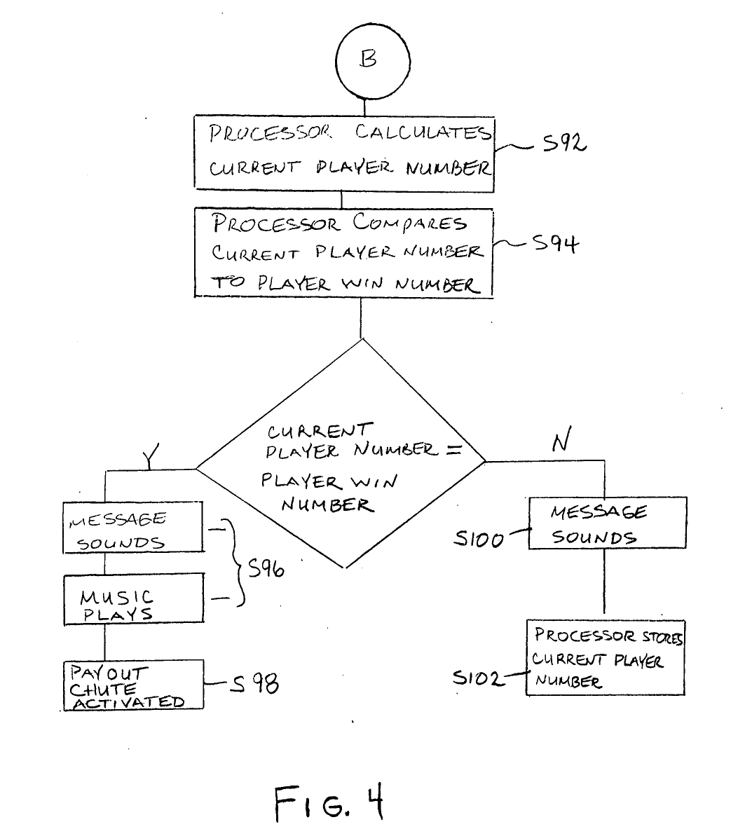

FIG. 3 is a flow chart depicting how a wager is determined on gaming device 10 and the subsequent steps thereafter. The steps that follow pertain to a gaming device 10 that has been designated as a $100 machine having a constant, predetermined minimum dollar amount to activate the machine, in this case, one dollar ($1). As described by the first step S80, the currency receiving device accepts the wager from the player and determines the amount that was deposited and then sends that information to processor 30. In step S82, the processor 30 calculates if amount deposited meets the minimum amount required to activate the gaming device display windows. If not, a message sounds at step S84, which tells the player he did not deposit the minimum amount to activate the machine. If the amount was correct or more than the minimum amount, then step 86 indicates that the processor 30 recalls the previously stored prior win credit limit from memory 42 and subtracts the amount deposited, thereby determining a current or new net wager credit limit, which is then simultaneously stored into the memory in step S88. Step S90 shows that value being displayed as information seen to the player on display device 22 and the prior win credit limit displayed as information appearing in display device 20. In step S92, (See FIG. 4) the processor 30 also calculates what player number the current player represents since the last jackpot was paid out. It does this step by adding a “one” to the previously stored player number. In step S94, processor 30 compares the current player number with the predetermined player number (100) stored in memory 42. If the current player number is equal to the predetermined player number (100), then step S96 shows that the speakers play music and an announcement is made that the player is an automatic jackpot winner. In step S98, the payout chute 28 is activated, whereby the jackpot is dispensed to the player. In step S100, if the processor 30 determines that the player does not meet the criteria of being the 100^{th} player, a message sounds, indicating that he is not the automatic winner. In step S102, the previous player number is deleted and the newly calculated player number is stored for future use in memory 42 and it will be considered the “previous” player number for the next play of the gaming device 10.

If the player is not an automatic winner by being the 100^{th} player, he will then have to place a wager within a designated time period. In step S104, if a player chooses to continue play, the processor 30 will determine if a wager is placed within the cut-out time period. If it is not, step S106 indicates that a message will sound to the player that he did not play in time and the machine will now deactivate. If the processor 30 determines that the wager was within the cut-out time period, then at step S108, the processor will use the information from currency receiving device 16 to establish the amount of the bet as a current wager credit limit. In step S110, the current wager credit limit is compared to the new net wager credit limit stored in memory 42. If the wager credit limit is not equal to the net credit limit, then at step S112, the display devices 18-22 are deactivated and a message sounds that the exact wager was not deposited. In that case, gaming device 10 effectively goes into hibernation with only the messaging device 14 running and wherein the processor 30, as step S114, will calculate a new previous credit limit by subtracting the current wager credit limit from the new net wager credit limit, whereby in step S116, that value is stored in memory 42 as the next prior win credit to be used in the next play of the gaming device 10.

In step S112, if the processor 38 determines that the exact amount (new net wager credit limit) was deposited as wager, then processor 30 sends a signal to payout chute 28 to activate itself in step S118 and the player is paid his winnings. In step S1120, the processor clears the new net wager credit limit stored in memory and resets the value to the predetermined value, in this case 100.

When the gaming device is programmed to utilize a random number generator for generating the minimum dollar activation amount, a few preliminary steps are performed prior to those presented in FIG. 3. In FIG. 3A, it is seen that in step S75, the processor 30 generates a random minimum dollar activation amount (hereinafter RMDAA). The RMDAA is then compared to the prior win credit value. If the RMDAA is less than the net prior win credit value, then the processor 30 resets the RMDAA value to the minimum dollar activation amount for the machine, which is step S76. The set RMDAA will then be displayed on messaging device 14, as in step S77. In this case, the minimum dollar activation amount will be set at 1% of the machine's designated dollar amount and will remain at that value until a jackpot is paid out. Once the jackpot is paid out (step S118), the random generator resorts back to generating random minimum dollar activation amounts and those values are displayed on the window of messaging device 14, as step S78 indicates. Likewise, if the compared values determine that the random minimum dollar activation amount is still greater than or equal to the net prior win credit value, then the information is displayed on the messaging device 14 (S78) and presented as the amount needed to activate play of gaming device 10.

As would be apparent to those skilled in the art, the present invention may be embodied in a wide variety of forms and electronic media, including, but not limited to video machines, stationery and hand-held electronic games and devices, lottery terminals, internet entertainment websites, CD's and floppy disks. For example, gaming device 10 can be implemented as a program code stored in a detachable cartridge for operating a hand held video game device. Alternatively, it can be implemented as a program code stored on a disk or other memory device that a player can use in a desktop or laptop personal computer or other computerized platforms. In addition, it is envisioned that the present invention can be readily implemented as a computer program product comprising a computer readable medium having control logic recorded therein to implement the features of the invention as described above. The control logic would be loaded within the CPU of the computer, which would then perform all operations necessary to execute the features of the invention such as determining the amounts of the wagers, determining which player number that player represents since the last jackpot was awarded, the payout functions, etc. In this context, FIG. 1 shows an arrangement of all the components as immediately described above for playing the simplified game of the invention.

With the methodology according to the present invention, a simply casino style gaming device is provided where gamblers are enticed to play a simple game that is readily understood by even novice players. While the methods and apparatus herein disclosed form a preferred embodiment of this invention, it will be understood that this invention is not so limited, and changes can be made without departing from the scope and spirit of this invention, which is defined in the appended claims.

I claim:

1. A gaming device for playing a game of chance, comprising:
a messaging device for displaying wagering information to a player on how to activate said gaming device;
a currency receiving device configured to receive and determine an amount of a wager deposited into said gaming device;
a processor and an associated memory device, said processor in communication with said currency receiving device, said processor including means for activating and controlling play of said gaming device based upon an amount of any wager received by said currency receiving device; and
at least one display device for displaying additional wagering information to a player in order for said player to make a decision to continue playing.

2. The gaming device of claim 1, wherein said currency receiving device is comprised of at least one of a coin and token slot, a bill slot, and a credit/debit slot, each of said slots capable of determining a dollar value of a wager deposited within said respective slot.

3. The gaming device of claim 1, further including a video controller and a combination of a touch screen and a touch screen controller in communication with said processor, said video and touch screen controllers configured to present a player with symbols generated on said touch screen, said symbols representing different forms of currency used as a gaming wager.

4. The gaming device of claim 3, wherein video controller, touch screen and touch screen controller are in communication with said currency receiving device through said processor.

5. The gaming device of claim 1, further including a payout chute connected to said processor for discharging a jackpot to a current player, said processor communicating directions to said payout chute to dispense said jackpot upon satisfaction of game winning criteria.

6. The gaming device of claim 5, wherein said game winning criteria is one of said current player depositing a wager of a predetermined amount into said currency receiving device and said current player being a predetermined successive player who has activated said gaming device.

7. The gaming device of claim 1, wherein said messaging device is comprised of a keyboard input component and a programmable controller having a continuous information display window, said keyboard used for inputting game activation information to said programmable controller such that said controller displays said information on said display window in a continuous fashion.

8. The gaming device of claim 5, further including means for audibly notifying a player that he has accomplished one of activating said gaming device for further game play and winning said jackpot, said means in communication with said processor.

9. The gaming device of claim 1, wherein said memory device is comprised of a first and a second portion, said first portion comprised of RAM memory and said second portion comprised of ROM memory.

10. The gaming device of claim 1, wherein said additional wagering information is comprised of a current player number, a dollar amount of monies the gaming device has received from previous players and a net dollar amount needed to be inputted into the gaming device as a wager in order to win the jackpot.

11. The gaming device of claim 7, wherein said activation wagering information displayed on said messaging device informs a player how many wagering dollars must be inputted into said gaming device in order to activate said at least one display device of said gaming device.

12. The gaming device of claim 11, wherein said amount of wagering dollars needed to activate said at least one display device is a predetermined and constant amount that is inputted through said keyboard for continuous display on said messaging device.

13. The gaming device of claim 11, wherein said amount of wagering dollars needed to activate said at least one display device is a random and constantly changing amount that is generated by said processor, wherein said processor is connected to said messaging device such that said random number is communicated to said messaging device for continuous display thereon.

14. The gaming device of claim 5, wherein said jackpot is comprised of one of a currency, house tokens, house casino chips, house discount coupons, a printed paper receipt redeemable for currency, and a debit card having a cash equivalent.

15. The gaming device of claim 14, wherein said printed paper receipt further includes a secondary game of change printed thereon, said secondary game of chance.

16. A gaming device for playing a game of chance, comprising:
a currency receiving device configured to receive and determine a dollar value of a wager deposited into said gaming device;
a processor and an associated memory device, said processor in communication with said currency receiving device, said processor including means for activating and controlling play of said gaming device based upon an amount of any wager received by said currency receiving device; and
at least one display device for displaying additional wagering information to a player in order for said player to make a decision to continue playing.

17. The gaming device of claim 16, further including a payout chute connected to said processor for discharging a jackpot to a current player, said processor communicating directions to said payout chute to dispense said jackpot upon satisfaction of game winning criteria.

18. The gaming device of claim 17, wherein said jackpot is comprised of one of a currency, house tokens, house casino chips, house discount coupons, a printed paper receipt redeemable for currency, and a debit card having a cash equivalent.

19. The gaming device of claim 18, wherein said printed paper receipt further includes a secondary game of change printed thereon, said secondary game of chance.
